(19) United States
(12) Patent Application Publication
(10) Pub. No.: US 2008/0316052 A1
(43) Pub. Date: Dec. 25, 2008

(54) Controller Unit, Communiction Device and Communication System as Well as Method of Communication Between and Among Mobile Nodes

(75) Inventor: Marco Ruffini, Dublin 9 (IE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,274

(22) PCT Filed: Jul. 22, 2005
(86) PCT No.: PCT/IB2005/052476

§ 371 Date: Jan. 18, 2007

(30) Foreign Application Priority Data
Jul. 22, 2004 (EP) 04103518.9
Dec. 22, 2004 (EP) 04106841.2
Mar. 30, 2005 (EP) 05102498.2

(51) Int. Cl. G08G 1/00

(52) U.S. Cl. 340/901

(57) ABSTRACT

In order to provide a communication system (100) as well as a method for communication between and among mobile nodes (10, 12, 14, 16), in particular between and among vehicles, with each node (10, 12, 14, 16)
broadcasting at least one message (22) and
receiving at least one arriving message (32, 34, 36) being broadcasted by at least one neighbouring node (12, 14, 16),
   wherein a flexible and immediate adjustment of the transmission power in accordance with the transmitting conditions, for example with the traffic density, is guaranteed, it is proposed
   (i) that the distance and/or number of the neighbouring nodes (12, 14, 16) is determined by means of the arriving messages (32, 34, 36), and
   (ii) that the transmission power for broadcasting the message (22) is selected in dependence on the distance and/or number of the neighbouring nodes (12, 14, 16), in particular in dependence on the average number of nodes as determined from the respective numbers of nodes sensed by the respective neighbouring nodes (12, 14, 16).

The present invention relates to a controller unit, in particular to a central data processing unit, for example to a relay control box, as well as to a method for controlling communication between and among mobile nodes, in particular between and among vehicles, each node being designed for receiving and transmitting messages, in particular
at least one hello message, and/or
least one data message, for example at least one warning message.

The present invention further relates to a corresponding communication device for communication between and among mobile nodes, in particular between and among vehicles, as well as to a communication system for wireless L[ocal]A[rea]N[etwork]s for communication between and among mobile nodes, in particular between and among vehicles.

The present invention further relates to a communication protocol for controlling communication between and among mobile nodes, in particular between and among vehicles, each node being designed for receiving and transmitting messages, in particular
at least one hello message, and/or
at least one data message, for example at least one warning message.

The choice of data rate and of transmission power for wireless local area networks (so-called wireless LANs or WLANs) is still an open problem. In fact so far these types of network are mainly used to connect multiple stations to a central access point. In this situation the best choice is to transmit with the highest data rate possible at the highest power available.

The reason is that the access point represents a “bottleneck”, and the choice of the highest data rate minimizes the time in which the access point is busy. The interference does not represent a main problem in this case because during the time the access point is busy, the nodes are not allowed to transmit to other nodes (in the standard operating mode).

A road safety wireless LAN has to function also without an access point. This implies that the mobile nodes mainly exchange messages with each other, and only occasionally connect to a fixed access point.

Under these conditions the choice of the highest data rate at the maximum power does not represent anymore the best solution because this implies a high level of interference preventing other nodes from exchanging messages.

In the prior art literature some proposals of data rate and power control selection mechanisms can be found. In prior art article “Efficient Power Control via Pricing in Wireless Data Networks” by Cem U. Saraydar, Narayan B. Mandayam, and David J. Goodman, IEEE Transactions on Communications, volume 50, issue 2, February 2002, pages 291 to 303, the concept of pricing function is introduced, which assigns a cost depending on the power used for every transmission. An algorithm is finally proposed minimizing this cost function for every node and giving a more equal distribution of the bandwidth.

In prior art article “Power controlled multiple access (PCMA) in wireless communication networks” by Nicholas Bambos and Sunil Kandukuri, INFOCOM 2000, 19th Annual Joint Conference of the IEEE Computer and Communications Societies, Proceedings, IEEE, volume 2, Mar. 26 to 30, 2000, pages 386 to 395, an algorithm regulating transmission power for every node depending on the number of messages in the queue waiting to be transmitted and on the power of the interference detected is proposed.

The results show that this algorithm achieves higher throughput compared to a standard constant signal-to-interference (so-called constant SIR) algorithm where the power is increased depending on the bit error rate calculated at the receiver.

Moreover, in prior art article “Multimodal Dynamic Multiple Access (MDMA) in Wireless Packet Networks” by Sunil Kandukuri and Nicholas Bambos, INFOCOM 2001, 20th Annual Joint Conference of the IEEE Computer and Communications. Societies, Proceedings; IEEE, volume 1, Apr. 22 to 26, 2001, pages 199 to 208, an extension of the algorithm is proposed also including the choice of data rate, beside the selection of the transmission power. Results show a further increase in the network throughput.

Regarding “reinforcement learning” reference can be made for example to prior art article “Reinforcement Learning: A Survey” by L. P. Kaeblling, M. L. Littman, and A. W. Moore, Journal of Artificial Intelligence Research 4, 1.996, pages 237 to 285. The main problem of these algorithms, mainly based on “reinforcement learning”, is that a slowly varying environment is assumed and particular access modes, for example C[ode]D[ivision]M[ultiple]A[ccess], is used. These algorithms allow getting a feedback by examining continuously the interference generated by the other nodes.

With this technique in fact nodes are allowed to transmit at the same time, using different codes; in this way if a node increases its transmission power, this creates interference to other nodes, which in order to keep on their own communication increase also their transmission power. In this way the first node is able to see the effect of its first increase in power, and can use this information in the next calculation of its transmission power.

However, these systems do not work in high mobility environments where the channel characteristics vary continuously and unpredictably. Moreover, with typical wireless LAN access modes, for instance C[arrier]S[ense]M[ultiple]A[ccess] type, the examination of the interference does not represent a fast and reliable feedback of the actions operated.

Exemplary systems matching the above description are further disclosed
in prior art article “Principles and Protocols for Power Control in Wireless Ad Hoc Networks” by Vikas Kawadia and P. R. Kumar, Wireless Ad Hoc Networks IEEE Journal on Selected Areas in Communications, Special Issue on Wireless Ad Hoc Networks, volume 1, January 2005),
in prior art document US 2003/0189906 A1 and
in prior art document WO 02/03567 A2.

Various transmission modes to optimize the overall system throughput are well known and implemented in the norm IEEE 802.11 WLAN of the Institute of Electrical and Electronic Engineers. These modes vary the modulation depending on the measured bit error rate. The better the quality of a connection is estimated to be, the higher the bit rate can be chosen.

In general, one of the primary objectives of a wireless local danger warning system is to warn as many nodes, in particular as many drivers, as possible whose life may be endangered for example by some road hazard. The use of existing wireless LAN technologies is attractive because well-tested products are commercially available and supported by the market. However, some functionality is to be added to the system to adapt the performance characteristics to road scenarios.

In prior art article “Distributed Power Control for Reliable Broadcast in Inter-Vehicle Communication System” by Marco Ruffini and Hans-Jürgen Reumerman, VANET 2004 (workshop within MOBICOM 2004 conference), Philadelphia, Pa., USA, Sep. 26 to Oct. 1, 2004, it is proposed to lower the bandwidth consumption by means of regulating the transmission power of broadcast messages without altering the reachability performances.

This mechanism allows efficient dissemination of messages under high and low density traffic situations but the proposed power control concept is only applicable to broadcast mode. In order to reuse the wireless local danger warning system for non-safety related applications, and thereby facilitate the market introduction, a peer-to-peer unicast transmission mode is necessary.

One of the technical challenges in peer-to-peer unicast mode is the trade-off between transmission rate and transmission power, which is required to optimize the network resources. On one side in fact a higher transmission rate increases the network throughput but on the other side it also requires higher transmission power, which increases the interference with other neighbours. Moreover, since broadcast and unicast messages coexist in the same system it becomes compulsory to apply transmit power rules to both message types, otherwise the messages of one type will overpower the others, which will give an unwanted prioritisation to one type of messages.

In wireless LAN networks the ambiguity in the choice of data rate and of transmission power has not yet been resolved.

Starting from the disadvantages and shortcomings as described above and taking the prior art as discussed into account, an object of the present invention is to further develop a controller unit of the kind as described in the technical field, a communication device of the kind as described in the technical field, a communication system of the kind as described in the technical field as well as a method with corresponding communication protocol of the kind as described in the technical field in such way that interference of messages transmitted between and among the mobile nodes is minimized and the overall local network throughput is maximized.

The object of the present invention is achieved by a controller unit comprising the features of claim 1, by a communication device comprising the features of claim 5, by a communication system comprising the features of claim 7, by a communication protocol comprising the features of claim 9 as well as by a method comprising the features of claim 10. Advantageous embodiments and expedient improvements of the present invention are disclosed in the respective dependent claims.

The present invention is principally based on the idea of a safety system for inter-vehicle communication with modulation and power control optimization; in this context, a data rate/transmission power decision algorithm is provided to adapt the data rate and the transmission power on a per packet basis, by gathering and processing information received from neighbouring nodes. In a fully distributed way this system reduces node interference and increases the overall network throughput.

Based on the estimated transmission time, on the averaged neighbour path loss, on the number of nodes interfered and in the probable time wasted for retransmission, a pricing function is calculated for a range of data rate and power margin values. The values of data rate and transmission power resulting in the lowest price is used to transmit the packet.

The present invention solves the ambiguity of choice of data rate and of transmission power, which is typical of wireless LAN networks, in particular by providing a standard defining a formal mechanism of selection of data rate and of transmission power, and is implementable in a completely distributed fashion.

In this context, the present invention is related to the field of power controlled safety systems and methods, in particular to the article “Distributed Power Control for Reliable Broadcast in Inter-Vehicle Communication System” by Marco Ruffini and Hans-Jürgen Reumerman, VANET 2004 (workshop within MOBICOM 2004 conference), Philadelphia, Pa., USA, Sep. 26 to Oct. 1, 2004, where a system for distributing warning messages (using only broadcast messages) among a group of vehicles is described. However, in contrast thereto, the present invention is not restricted to broadcast messages.

According to a preferred embodiment of the present invention the basic functionality of existing wireless local area network (WLAN) systems and methods is exploited and some modifications and improvements are applied to adapt the existing W[ireless]L[ocal]A[rea]N[etwork] systems to the distributed and highly mobile environment of inter-vehicle communication.

According to a particularly inventive refinement, the system as well as the method according to the present invention can generate different types of messages and is able to transmit these different types of messages choosing both transmitting power and data rate. The choice is made in a way minimizing the interference between the neighbours; this technical measure corresponds with the aim of the present system to maximize the overall local network throughput.

Preferably, the system as well as the method of the present invention are designed to decide over which pathloss values their average should be calculated.

According to an advantageous embodiment of the present invention the system and the method use information of pathloss received by neighbouring nodes to adapt the data rate and the transmission power of transmitted packets.

In particular, the system and/or the method may use a price function based on for example
the number of neighbours,
the pathloss information of these neighbours,
the transmission packet length,
the information about sensitivity of modulation,
the probability of packet loss,
the power margin,
the maximum transmission power,
the channel assessment avoidance threshold, and/or
the priority of the messages.

According to an expedient embodiment of the invention the present system as well as the present method associate the minimum price function to the minimum interfering mode, where a mode is referred to as a pair of data rate and of transmit power; in particular, the system as well as the method according to the present invention automatically eliminate the transmitting modes being not compatible with the maximum transmission power.

According to a particularly inventive refinement of the present invention, the system as well as the method according to the present invention retransmit the packet when no acknowledgement signal is received, by recalculating the price function, and favouring the use of a higher power margin.

In general, the present invention, in particular the communication device as described above can be applied and installed in every vehicle moving on road. Said communication device can constitute by itself a complete structure to achieve wireless local danger warning, with the ability of self-adaptation to different circumstances and scenarios.

Moreover, said communication device can also be included as a part of a more complex protocol stack as for example a protocol being designed for retransmitting the message, in particular packet, when no acknowledgement is received, by recalculating the price function, and favouring the use of a higher power margin. For example a general protocol can embody the present invention to solve the general problem of correct choice between data rate and transmission power, independently of the purpose of the communication system and of the data transmitted.

In particular, the present invention finally relates to the use of at least one controller unit as described above and/or of at least one communication device as described above and/or of at least one communication system as described above and/or of at least one communication protocol as described above and/or of the method as described above for at least one wireless ad hoc network, in particular for at least one sensor network or for wireless local danger warning with the ability of self-adaptation to different circumstances and scenarios, for example for car-to-car communication, wherein cars interact cooperatively and distribute for example warning messages, especially for accident-free driving, for instance
in order to avoid collisions during lane change or merge maneuvers and
for reporting invisible obstacles, for example obscured or shadowed objects, when vehicles are moving in different directions within the same area.

Finally, the present invention can also be used for transmitting general data messages to support safety-oriented, telematics-oriented and/or entertainment-oriented applications.

As already discussed above, there are several options to embody as well as to improve the teaching of the present invention in an advantageous manner. To this aim, reference is made to the claims respectively dependent on claim 1, on claim 5, on claim 7, and on claim 10; further improvements, features and advantages of the present invention are explained below in more detail with reference to preferred embodiments by way of example and to the accompanying drawings where

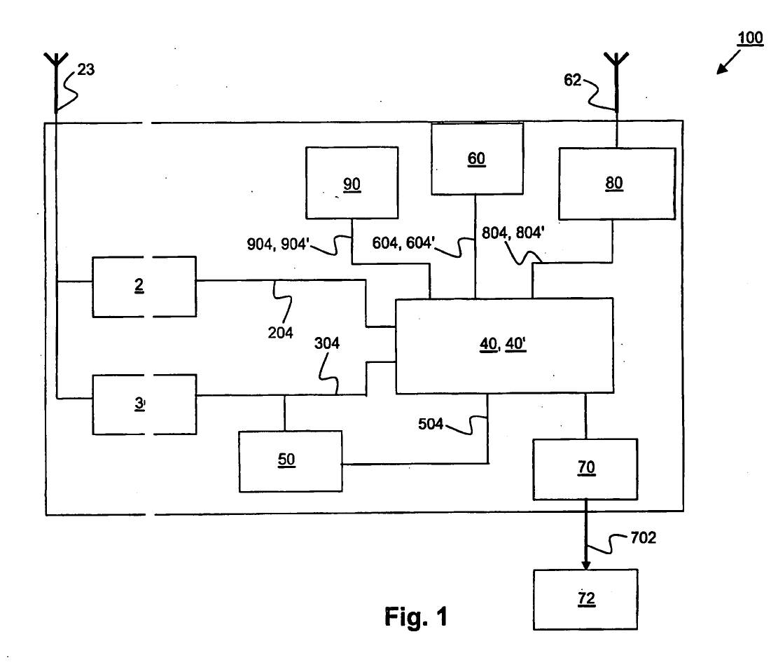

FIG. 1 schematically shows an embodiment of a communication device according to the present invention being operated according to the method of the present invention;

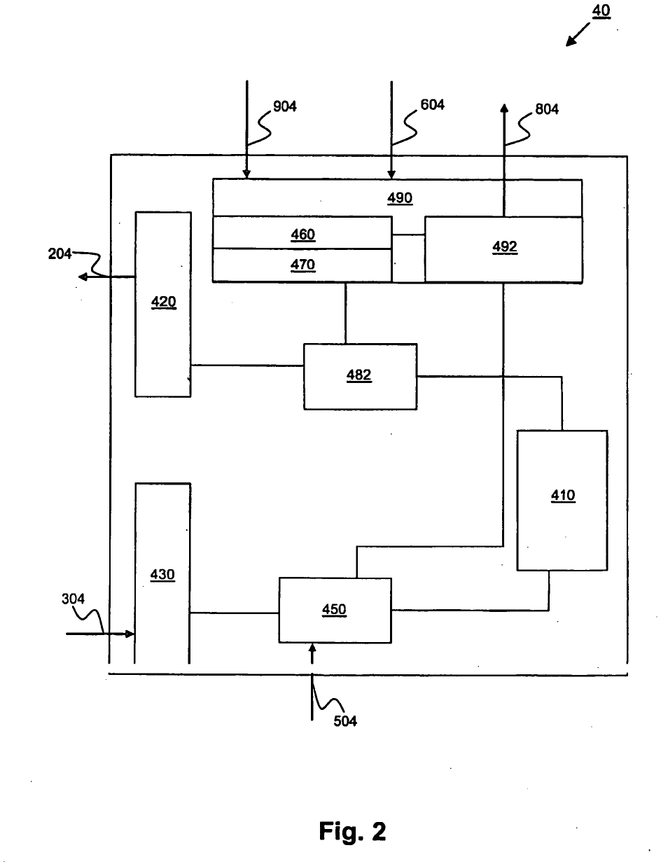

FIG. 2 schematically shows a first embodiment of a controller unit or central data processing unit being comprised in the communication device of FIG. 1;

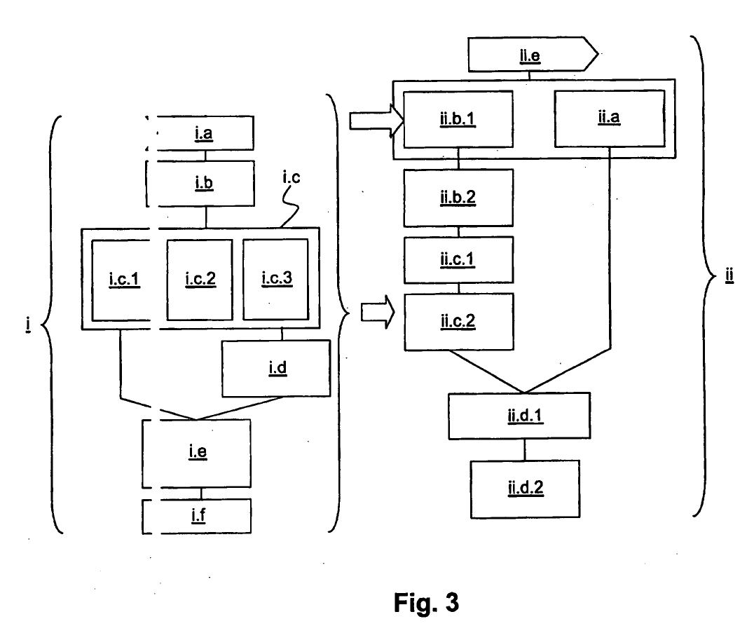

FIG. 3 schematically shows a block diagram illustrating an embodiment of the method according to the present invention;

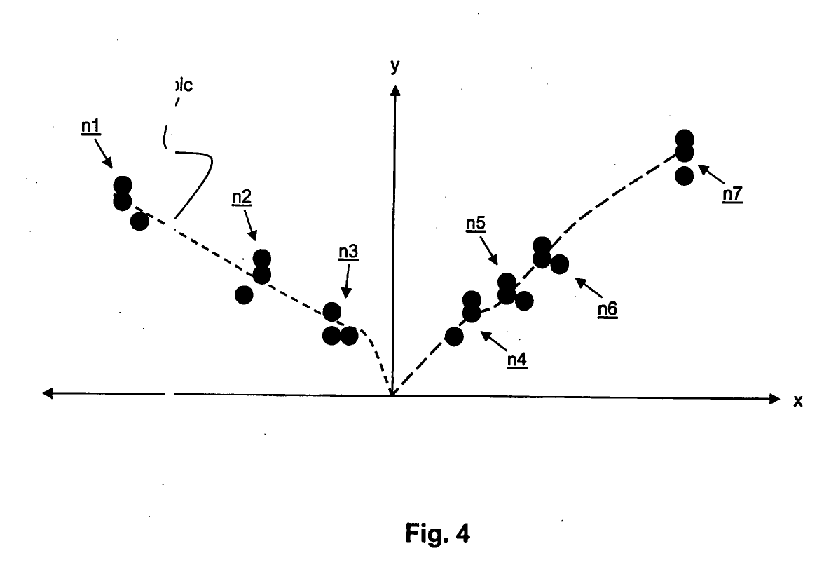

FIG. 4 schematically shows a path loss estimation from the hello messages of the neighbours according to the method of FIG. 3;

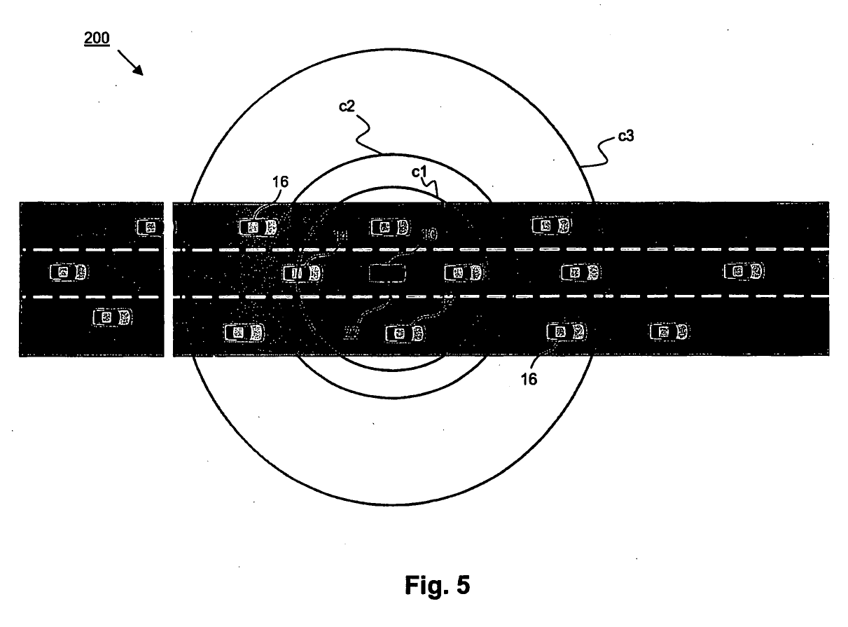

FIG. 5 schematically shows an example of application of inter-vehicular communication according to the present invention in the case of high traffic scenario;

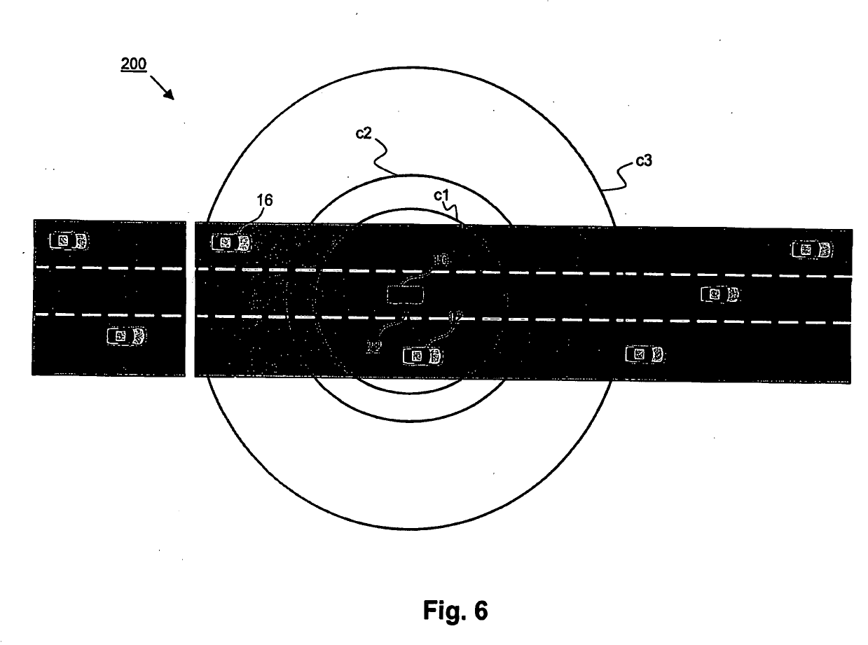

FIG. 6 schematically shows an example of application of inter-vehicular communication according to the present invention in the case of low traffic scenario;

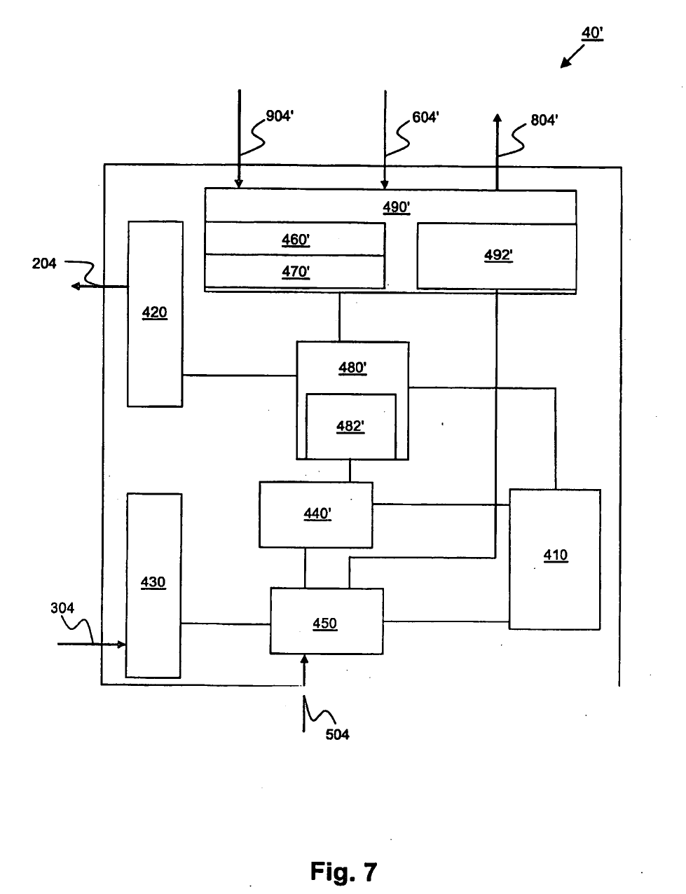

FIG. 7 schematically shows a second embodiment of a controller unit or central data processing unit being comprised in the communication device of FIG. 1;

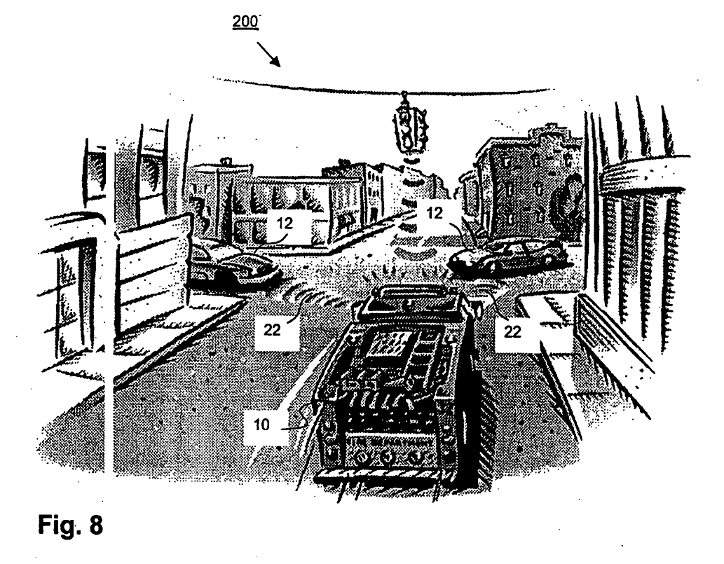

FIG. 8 perspectively shows a first example of application of inter-vehicular communication in the case of a crossing or of an intersection (source: US DoT intelligent vehicle initiative);

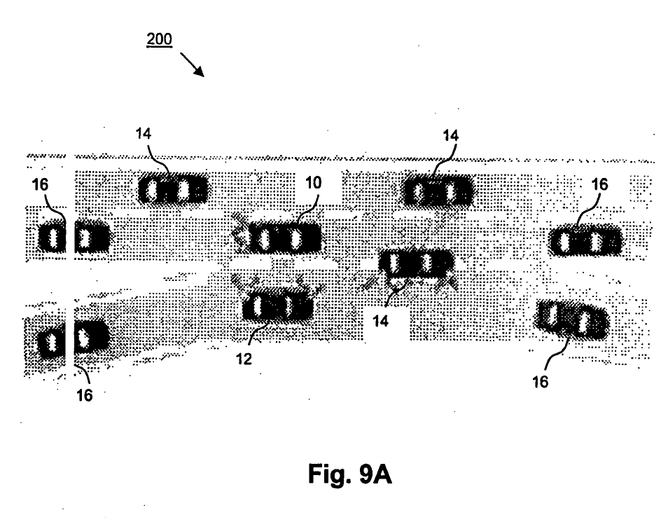

FIG. 9A schematically shows a second example of application of inter-vehicular communication in the case of lane change or merge manoeuvre (source: CarTalk project);

FIG. 9B schematically shows a third example of application of inter-vehicular communication in the case of an accident ahead (source: CarTalk project); and

FIG. 9C schematically shows a fourth example of application of inter-vehicular communication in the case of an invisible obstacle (source: CarTalk project).

The same reference numerals are used for corresponding features or parts in FIG. 1 to FIG. 9C.

In order to avoid unnecessary repetitions, the following description regarding the embodiments, characteristics and advantages of the present invention relates (unless stated otherwise)
to the embodiment of the communication device 100 (cf. FIG. 1) according to the present invention as well as
to the first embodiment of the controller unit, namely to the central data processing unit 40 (cf. FIG. 2), according to the present invention as well as
to the second embodiment of the controller unit, namely to the central data processing unit 40′ (cf. FIG. 7), according to the present invention,
all embodiments being operated according to the method of the present invention.

Basically, a concept of transmission rate/power decision pertaining to a system 200 (cf. FIGS. 5, 6, 8, 9A, 9B, 9C) as well as to a method for wireless local danger warning is described by the present invention. The system 200 and the method are used to disseminate warning messages among vehicles as well as among roadside units and can also be used for transmitting general data messages to support many possible safety-oriented, telematics-oriented and/or entertainment-oriented applications.

In correspondence thereto, the algorithm is developed for communication among moving vehicles but can also be embedded in every communication protocol making use of a shared wireless medium.

The general system architecture of the communication device 100 being assigned to the communication system 200 according to the present invention is depicted in FIG. 1. This embodiment is specifically adapted to an IEEE 802.11 type network as described in “The International Standard ISO/IEC 8802-11, Part 11: Wireless LAN Medium Access Control (MAC) and Physical Layer (PHY) Specifications”, 1999(E) ANSI/IEEE Standard 802.11 but the principles can be generally extended to every type of network.

The communication device 100 as shown in FIG. 1 is designed for communication between and among mobile nodes 10, 12, 14, 16, for example between and among a reference vehicle 10 (=considered car) and neighbouring cars 12, 14, 16.

The communication device 100 comprises
a transmission unit 20, namely a sender block, for sending messages 22, namely hello messages and data messages, for example warning messages,
a receiver unit 30, namely a receptor block, for sensing arriving messages, namely hello messages and data messages, being transmitted by the neighbouring cars 12, 14, 16, and
a central data processing unit 40, 40′, in particular a control unit or relay control box, implementing all the functions needed for the control of the data rate and power used
to unicast messages (central data processing unit 40; cf. FIG. 2) and/or
to broadcast messages (central data processing unit 40′; cf. FIG. 7).

The central data processing unit 40, 40′ is configured for calculating the transmitting power and the data rate for sending the messages 22 by processing at least part of the arriving message, in particular by processing information regarding the neighbouring cars 12, 14, 16.

The receiver unit 30 is connected
to a receiving/transmitting antenna 23 and
to the central data processing unit 40, 40′ as well as to a power estimating unit 50 being designed for calculating the receiving power 504 at which the arriving message is received.

The receiving/transmitting antenna 23 is assigned to the transmission unit 20 as well as to the receiver unit 30.

For receiving signals
regarding the current position of the respective car 10 and/or
regarding the moving direction of the respective car 10
via a localisation antenna 62, namely via a G[lobal]P[ositioning]S[ystem] antenna, the central data processing unit 40, 40′ is connected with a localisation unit 60, namely with a G[lobal]P[ositioning]S[ystem] unit.

Moreover, the central data processing unit 40, 40′ is connected with a danger sensing unit 90 being designed for sensing one or more subjects being relevant, in particular dangerous, for the considered car 10 and/or for the neighbouring cars 12, 14, 16.

To be supplied with the speed of the respective car 10, the central data processing unit 40, 40′ is connected with a car bus interface 70. Said car bus interface 70 supplies a car bus intra-vehicle system 72 with signals 702 being sent from the car bus interface 70 to the car bus intra-vehicle system 72.

Moreover, the communication device 100, 100′ comprises a display unit 80 displaying messages, in particular the arriving messages, for example the data messages. Said display unit 80 again is connected to the central data processing unit 40, 40′.

Each vehicle 10, 12, 14, 16 equipped with the communication device 100 described in FIG. 1 periodically transmits hello messages containing information about
the respective power at which the hello message had been transmitted,
the respective current position of the vehicle 10, 12, 14, 16 (supplied by the G[lobal]P[ositioning]S[ystem] block 60),
the respective heading direction or moving direction of the vehicle 10, 12, 14, 16 (supplied by the G[lobal]P[ositioning]S[ystem] block 60),
the respective speed of the vehicle 10, 12, 14, 16 (supplied by the car bus interface 70),
the respective network identification number of the vehicle 10, 12, 14, 16, and
a respective timestamp and potentially including also other relevant information.

FIG. 2 depicts the first embodiment of the central data processing unit 40 in more detail; FIG. 7 depicts the second embodiment of the central data processing unit 40′ in more detail. Said central data processing unit 40, 40′ comprises a neighbour list or neighbour table 410 being designed for storing the hello messages.

In the following table, the specification of the neighbour table 410 is depicted, wherein the second column depicts the respective current position of the vehicle 10, 12, 14, 16 and the third column depicts the respective heading direction or moving direction of the vehicle 10, 12, 14, 16:

| | | | | | path | path | path | path | path | path |
|---|---|---|---|---|---|---|---|---|---|---|
| | | | | | loss | loss | loss | loss | loss | loss |
| ID | pos. | dir. | speed | timestamp | (0) | (1) | (2) | (3) | ( . . . ) | (last) |
| 1 | (41, 3) | 125° | 125 | 18:21:01:234 | 81.5 | 80.6 | 86.7 | 88.0 | . . . | 84.3 |
| 2 | (53, 6) | 125° | 110 | 18:21:01:783 | 79.1 | 82.3 | 76.6 | 82.2 | . . . | 85.4 |
| 3 | (73, 9) | 125° | 115 | 18:21:01:945 | 65.3 | 67.6 | 71.0 | 64.8 | . . . | 69.9 |
| 4 | (120, 3) | 125° | 130 | 18:21:01:986 | 100.2 | 96.8 | 94.3 | 97.6 | . . . | 94.7 |

Additionally other values can be added in the neighbour table 410; for example instead of storing only the history of path loss values, the history of pairs (x=distance; y=path loss) can be stored as depicted in FIG. 4.

The hello messages are transmitted in broadcast mode such that every node 10, 12, 14, 16 able to decode the hello message can create an entry in its neighbour table 410 and update the information every time a new hello message from the same node 10, 12, 14, 16 is received.

When no hello message is received from a given node or neighbouring node 12, 14, 16 for a certain amount of time, which can for example be fixed by defining the value of the parameter “max_time” in the system 200, the entry relative to that neighbouring node 12, 14, 16 is deleted from the neighbour table 410 of the reference node 10.

As depicted in FIGS. 2 and 7, for receiving the arriving messages from the receiver unit 30, the relay control box 40, 40′ comprises a receiver interface 430 being supplied with signal 304.

Said receiver interface 430 is connected with a message analysing unit 450 for
evaluating the subject or the type of the arriving messages, in particular for evaluating if the arriving message is a hello message and/or a data message,
for updating the information regarding the neighbouring nodes 12, 14, 16 stored in the neighbour table 410, with at least part of the arriving messages, namely with the hello messages, and
for sending (reference numeral 804 in FIGS. 1 and 2; reference numeral 804′ in FIGS. 1 and 7) a copy of at least part of the arriving messages, namely of the data messages, to the display unit 80.

To this aim, the message analyzing unit 450 is connected to the receiver interface 430 as well as to the neighbour table 410 as well as to a data managing unit 490, 490′, in particular to a data processing unit or data processor 492, 492′, and provided with the receiving power 504 as calculated by the power estimating unit 50 (cf. FIG. 1).

The data managing unit 490, 490′ further comprises
a data message generating unit 460, 460′
being designed for generating one or more general data messages, and
being connected with the data processing unit 492, 492′ and
a hello message generating unit 470, 470′
being designed for providing the decision unit 482, 482′ with at least one hello message, and
being connected with the decision unit 482, 482′.

The data managing unit 490, 490′ can be provided with
at least one signal 604, 604′ from the localisation unit 60 to the central data processing unit 40, 40′, in particular to the data managing unit 490, 490′, for example to the data message generating unit 460, 460′, and
at least one signal 904, 904′ from the danger sensing unit 90 to the central data processing unit 40, 40′, in particular to the data managing unit 490, 490′, for example to the data message generating unit 460, 460′.

The data managing unit 490, 490′ is designed for sending a signal 804, 804′ from the central data processing unit 40, 40′, in particular from the message analyzing unit 450 and/or from the data processing unit 492, 492′, to the display unit 80.

The decision unit 482, 482′ is the core of the communication device 100. In said decision unit 482, 482′ a set of rules are defined, which regulate
the data rate, namely the transmission rate, and
the transmission power
on a per packet basis with the aim of minimizing interference towards the other nodes 10, 12, 14, 16. In this way, all the nodes or vehicles 10, 12, 14, 16 cooperate to maximize the network efficiency.

For transmitting the message 22 being generated by the data message generating unit 460, 460′ or by the hello message generating unit 470, 470′ to the transmission unit 20, the relay central data processing unit 40, 40′ comprises a transmission interface 420 being connected to the decision unit 482, 482′ and being designed for transmitting at least one signal 204 to the transmission unit 20. The decision unit 482, 482′ in turn is connected with the neighbour table 410.

Thus, FIGS. 2 and 7 give an insight of the central data processing unit 40, 40′: messages 22 are generated in the data managing unit or data manager 490, 490′ by the data message generating unit 460, 460′ or by the hello message generating unit 470, 470′. The message generation process can be triggered externally by the danger sensing unit 90 (cf. FIG. 1) or internally by the data processor 492, 492′ of the data manager 490, 490′.

Hello messages can be transmitted at variable or preferably maximum power, and together with data messages being processed in the decision unit 482, 482′. This decision unit 482, 482′ uses the information collected in the neighbour table 410 and runs an algorithm determining the best rate and transmission power for this message transmission by following the principles as described by the pricing function (cf. step [ii.d.1] below).

Thereupon, all the messages 22 pass through the transmission interface 420, which is used to adapt the central data processing unit 40, 40′ to the different transmission protocols being usable by the transmitter unit or transmission unit 20 (cf. FIG. 1), before being sent to the transmitter unit 20.

Messages 22 incoming from the receiver unit 30 (cf. FIG. 1) are passed to the receiver interface 430, being used to adapt the data processing unit 40, 40′ to the different transmission protocols being usable in the receiver unit 30 (cf. FIG. 1).

Then, messages 22 are passed from the receiver interface 430 to the message analysing unit 450 for deciding if the message 22 arrived is a general data message or a hello message.

In case of hello message, an entry is created (or updated) in the neighbour table 410, with the information provided by the hello message plus the power displayed by the power estimating unit 50; this is inserted into the head of the array of path loss values.

In case the incoming message 22 is a general data message, the central data processing unit 40, 40′ sends a copy to the data processor 492, 492′ inside the data manager 490, 490′ which will process the data message and decide if the income general data message is relevant enough to be displayed at the display unit 80 (cf. FIG. 1). The data processor 492, 492′ is also endowed with a memory with enough capacity to store a certain amount of messages 22.

The reference vehicle 10, comprising a communication system 100 as described in FIGS. 1, 2 (=first embodiment) or described in FIGS. 1, 7 (=second embodiment) estimates the path loss of the neighbouring cars 12, 14, 16 by means of the information comprised in the hello messages broadcasted by the neighbouring cars 12, 14, 16.

As depicted in FIG. 3, path loss estimation from the hello messages as received from the neighbours 12, 14, 16 comprises the following steps:

In a first step [i.a], the hello messages as broadcasted by the neighbouring cars 12, 14, 16 are received.

In a second step [i.b],
the receiving power 504 is determined at which the arriving hello message is received and
the path loss is determined by comparing the determined receiving power 504 or received signal strength of the respective hello messages with the transmit power indicated in the header of these hello messages.

In this context, “path loss” is the attenuation of the transmission power, in particular of the electromagnetic wave strength, of the message or signal between the time it leaves the transmission unit 20, for example of a neighbouring car 12, 14, 16, and the time it arrives at the receiving unit 30, for example of the reference vehicle 10. The quality of a channel of the communication system 200 depends on the path loss.

In a third step [i.c], the instant path loss for each vehicle is stored in the neighbouring table 410, for example
the instant path loss for the first neighbouring vehicle 12 is stored in step [i.c.1],
the instant path loss for the second neighbouring vehicle 14 is stored in step [i.c.2], and
the instant path loss for the further neighbouring vehicle 16 is stored in step [i.c.3].

On receipt of a message 22, the message analyzing unit 450 evaluates if it is a hello message or a general data message:

In the first case, the message analyzing unit 450 uses the hello message to update the neighbour table 410 (cf. neighbour table above) in step [i.f], as will be explained below.

In the latter case, i.e. if the receipt message 22 is a data message the message analyzing unit 450 sends this data message to the data processing unit 492, 492′ to evaluate if the message has to be sent to the display 80 and if the data message has to be further processed and eventually supplied to the data generating unit 460, 460′.

In a next step [i.e], the average path loss and the path loss variance per neighbour 12, 14, 16 are calculated.

The neighbour table 410 includes for each entry the same information contained in the correspondent hello message, plus an array of recorded path loss values (cf. neighbour table above), the most recent of which is provided by the power estimating unit 50 (cf. FIG. 1) when the hello message is received. These path loss values are used to calculate the averaged path loss as well as the path loss variance.

The averaged path loss value is obtained by averaging a variable number of instant path loss values, which are calculated by subtracting the value received by the power estimator 50 (cf. FIG. 1) from the power transmitted value included in the message received (cf. step [1.c] above).

The path loss variance is instead the variance of the instant path loss values considered in the averaged path loss, calculated following the usual formula

$$\{ \begin{matrix}{σ}^{2} = \frac{{\sum }_{i}^{ } {( {x}_{i} - μ )}^{2}}{N} \\ {x}_{i} > μ\end{matrix} ,$$

where μ represents the averaged path loss.

According to the present invention, in the calculation only the values xi where the path loss is higher than the average value/are included as clarified below (cf.
step [ii.d.1] of minimizing the interference time with neighbours 12, 14, 16 and
step [ii.d.2] of selecting the resulting power/bit rate value).

It is important that the number of values over which the average is calculated is variable, and it has to be chosen considering estimations made about the channel characteristics and hello messages repetition rate.

Between steps [i.c.1], [i.c.2], [i.c.3] and step [i.e], a step [i.d] of calculating the general path loss characteristics plc (cf. FIG. 4) may be inserted.

The path loss average is computed from a number of path loss values regularly measured by comparing transmit power and receive power from hello messages delivered by neighbouring vehicles 12, 14, 16. Each vehicle 10, 12, 14, 16 averages the path loss value to be independent of the fast fading effect of the transmission channel, where fading refers to the signal deterioration due to multiple reflections at stationary objects and/or at moving objects.

If the frequency of path loss measurements is too low, then the environment may have changed a lot and consequently the fading effect is not sufficiently considered, while if the frequency is too high then the free space loss effect dominates and deteriorates the quality of the averaging process.

Therefore, the frequency of path loss measurements, closely depending on the frequency of hello messages sent or received, can advantageously be varied considering an estimated free space loss for the channel which can be derived and extrapolated from the information contained in the hello messages. The extrapolation can be done by means of existing methods, as for instance minimum square difference.

When averaging the path loss derived from the hello messages transmitted for example every hundred milliseconds from the same vehicle 10, 12, 14, 16, it can be assumed that the environment of the vehicle remains stable and the fading effect can be neglected.

Taking into consideration that regularly hello messages from more than one vehicle are received, and that those vehicles move very slowly compared to the hello message rate, a path loss model can be approximated and a graph on received power (=variable y in FIG. 4) over distance (=variable x in FIG. 4) can be drawn. FIG. 4 explains the path loss estimation from the hello messages of the neighbours 12, 14, 16 as described above.

As depicted in FIG. 4, from values of distance x and corresponding path loss y it is possible to extrapolate a path loss characteristic plc. The extrapolated path loss characteristic plc can be used to understand how the path loss y changes with the distance x, and the information can be used to decide the number of path loss values on which the average path loss should be calculated.

If for example the values of path loss change are within one decibel to two decibel for a distance between 120 meters and 130 meters, then all the path loss values coming from the same neighbour within this range can contribute to the calculation of the average path loss for this neighbour.

Referring to FIG. 4, the following table specifies the details of the neighbour list and displays the grouping of neighbour cars 12, 14, 16 in different network identification numbers:

| | distance(m)/pathloss(dB) pair values | | |
|---|---|---|---|
| node ID | t = 0 | t = 1 | t = 2 |
| 1 | (−110; 82) | (−108; 76) | (−105; 74) |
| 2 | (−86; 65) | (−88; 68) | (−90; 71) |
| 3 | (−29; 41) | (−27; 36) | (−24; 34) |
| 4 | (41; 53) | (44; 58) | (48; 62) |
| 5 | (53; 56) | (51; 57) | (50; 53) |
| 6 | (73; 71) | (71; 74) | (68; 66) |
| 7 | (152; 110) | (150; 107) | (147; 103) |

As further depicted in FIG. 3, the selection of the data rate and of the transmission power comprises the following steps:

First, the interference time per available bit rate is calculated in a step [ii.a].

Every time a node, for example the reference vehicle 10, wants to transmit a hello message and/or a data message, for example a packet of messages 22, the node calculates the estimated time durations of the transmission for every data rate available because the transmission time depends on the data rate used.

The estimated time duration represents the effective time used to send the packet; therefore the estimated time duration has to include preambles and all the various system overhead; for example, in the IEEE 802.11 case also the D[istributed Coordination]I[nter]F[rame]S[pacing] parameter has to be considered.

These values are stored in variables named T_{mod}, where “mod” indicates the type of modulation or data rate considered. The formula for transmission time calculation is available in prior art document “802.11 Efficiency Analysis” by F. Dalmases, PFL-Aachen Technical Note 9/2002.

In the step [ii.a] of calculating the interference time per available bit rate also the time spent for the eventual use of acknowledgments (ACK) or other transmission related system functionalities can be included, for instance R[eady]T[o]S[end]/C[lear]T[o]S[end] mechanism as disclosed in “The International Standard ISO/IEC 8802-11, Part 11: Wireless LAN Medium Access Control (MAC) and Physical Layer (PHY) Specifications”, 1999(E) ANSI/IEEE Standard 802.11.

The following table explains the selection of the data rate and of the transmission power as described above, wherein it is assumed that the message 22 to be transmitted comprises a packet length of 120 bytes. The column “time to transmit the packet T_{mod}(μs)” considers the time to send the message 22 or packet and the time to receive the corresponding acknowledgment:

| bit rate | time to transmit the |
|---|---|
| (Mbps) | packet T_{mod} (μs) |
| 54 | 186.815 |
| 48 | 189.917 |
| 36 | 199.222 |
| 24 | 217.833 |
| 18 | 236.444 |
| 12 | 273.667 |
| 9 | 310.889 |
| 6 | 385.333 |

The step [ii.b.1] of determining the path loss to the receiver 30 is to calculate the power required in order to have the transmitted packet or message 22 correctly decoded at the receiver unit 30 (cf. FIG. 1). This is actually a probabilistic issue but in the communication device 100 according to the present invention the value of the averaged path loss is considered available from the neighbour table 410.

Every different modulation has a fixed sensitivity value S_{mod} indicating the minimum power needed to decode the message 22. By summing each of these sensitivity values S_{mod} to the averaged path loss Pl_{avg}, a set of values P_{mod}(=S_{mod}+Pl_{avg}) is obtained wherein the values P_{mod} indicate, for each modulation, the power at which the node has to transmit its message in order to reach the receiver unit 30 with the correct power.

The following table explains the step [ii.b.1] of determining the path loss to the receiver 30 as described above, wherein it is supposed that a message 22 with an average path loss value Pl_{avg} of 102 decibel is to be transmitted to the second node. Moreover, it is supposed that in step [ii.b.2] of calculating the required transmission power per available bitrate the maximum transmission power (E[ffective]I[sotropic]R[adiated]P[ower]) is thirty decibel:

| | | | power needed to reach second |
|---|---|---|---|
| | minimum | P_{mod} = | neighbour with received power |
| bit | sensitivity | S_{mod} + Pl_{avg} | equal to minimum sensitivity |
| rate | S_{mod}(dBm) | [symbol] | P_{mod} |
| 54 | −65 | | 37 dBm |
| 48 | −66 | | 36 dBm |
| 36 | −70 | | 32 dBm |
| 24 | −74 | | 28 dBm |
| 18 | −77 | | 25 dBm |
| 12 | −79 | | 23 dBm |
| 9 | −81 | | 21 dBm |
| 6 | −82 | | 20 dBm |

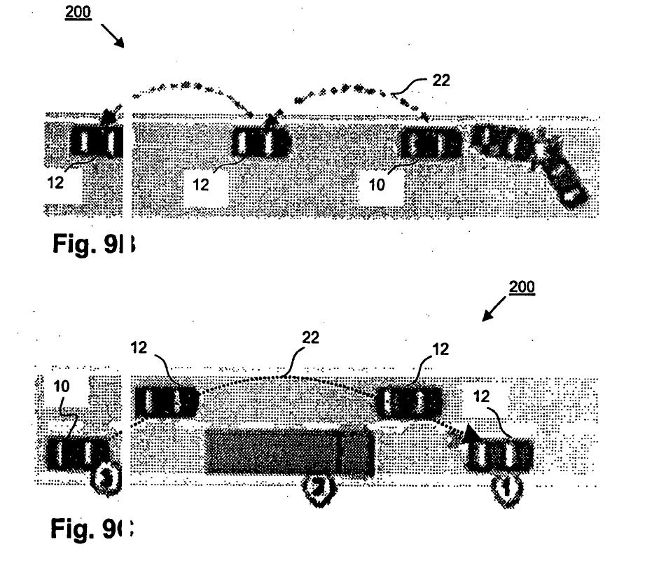

The figures 37 dBm (=decibel milliwatt), 36 dBm, 32 dBm in the first three lines represent values going over the maximum transmission power of the transmitter, for instance over thirty decibel milliwatt.

After
the step [ii.b.1] of determining the path loss to the receiver unit 30 and the step [ii.b.2] of calculating the required transmission power per available bit rate,

for every modulation different or various power margin values have to be considered and applied in step [ii.c.1], which are added to the value P_{mod} calculated. The power margin is used to increase the transmission power; in fact the P_{mod} values are calculated on the basis of the average path loss.

Since, as stated above, the actual path loss is a probabilistic value, increasing the transmission power (by increasing the margin) also increases the probability of correct message reception. The different margin values are stored in variables named Mₙ. In this context, it has to be taken into account that increasing transmitted power also increases the communication interference experienced by the other nodes.

For each couple of values {P_{mod}, Mₙ} the sum P_{mod,n}^{tot}=P_{mod}+Mₙ is calculated, and to this number P_{mod,n}^{tot} the number of neighbours N_{mod,n} is associated which will be interfered when using this transmission power.

In this context, a node is considered to be interfered when it detects a minimum power level for which it considers the transmission medium as busy. In the case of IEEE 802.11 this corresponds to the threshold th_{caa} of the channel assessment avoidance. In this way, the value of the path loss within which the nodes are interfered can be calculated by the formula I_{mod,n}=P_{mod,n}^{tot}−th_{caa}.

The value N_{mod,n} is calculated from the neighbour table 410 representing the number of neighbours 12, 14, 16 the average path loss value of which is less than I_{mod,n}.

In the following,
the step [ii.c.1] of applying various power margins and
the step [ii.c.2] of calculating the interference range per available power level are explained in more detail by the way of example:
[a] A node 10, 12, 14, 16 is interfered when it receives a signal with a power higher than a channel assessment avoidance threshold th_{caa} of −82 decibel milliwatt.
[b] The sum of P_{mod} and Mₙ gives the total power P_{mod,n}^{tot}(=P_{mod}+Mₙ) wherein P_{mod} depends on the modulation while Mₙ are the margin values starting from one decibel and being separated by a certain step; for instance the step might be one decibel, i.e. the values of Mₙ might be M₁=1 dB, M₂=2 dB, M₃=3 dB, M₄=4 dB, M₅=5 dB.
[c] The algorithm calculates the minimum path loss value I_{mod,n}=P_{mod,n}^{tot}−th_{caa}(dB), at which neighbours 12, 14, 16 are interfered.

In the following table, these steps [a], [b], [c] as described above are depicted, wherein
the first column col1 shows the bit rate per Mbps,
the second column col2 shows the transmission power P_{mod}(dBm),
the third column col3 shows P_{mod}+M₁(dBm),
the fourth column col4 shows P_{mod}+M₂(dBm),
the fifth column col5 shows P_{mod}+M₃(dBm), and
the sixth column col6 shows P_{mod}+M₄(dBm);
   the seventh column co17, the eighth column col8, the ninth column col9, and the tenth column col10 depict the minimum path loss value at which neighbours 12, 14, 16 are interfered calculated by the formula I_{mod,n}=P_{mod,n}^{tot}−th_{caa}(dB):

| | | | | | | col7 | col8 | col9 | col10 |
|---|---|---|---|---|---|---|---|---|---|
| | | | | | | using | using | using | using |
| col1 | col2 | col3 | col4 | col5 | col6 | M₁ | M₂ | M₃ | M₄ |
| 24 | 28 | 29 | 30 | 31 | 32 | 111 | 112 | — | — |
| 18 | 25 | 26 | 27 | 28 | 29 | 108 | 109 | 110 | 111 |
| 12 | 23 | 24 | 25 | 26 | 27 | 106 | 107 | 108 | 109 |
| 9 | 21 | 22 | 23 | 24 | 25 | 104 | 105 | 106 | 107 |
| 6 | 20 | 21 | 22 | 23 | 24 | 103 | 104 | 105 | 106 |

[d] Values over the maximum transmission power, for instance over thirty decibel milliwatt, are excluded from the calculation (31 decibel milliwatt and 32 decibel milliwatt in the above table).
[e] From the neighbour list 410 (cf. table below) now it can be counted how many nodes have an average pathloss lower than the ones displayed in the table below; these are the values N_{mod,n}.

The following table depicts a detail of the neighbour table 410:

| node ID | average pathloss |
|---|---|
| 1 | 89 |
| 2 | 96 |
| 3 | 104 |
| 4 | 106 |
| 5 | 108 |
| 6 | 110 |
| 7 | 112 |

The following table depicts the values N_{mod,n}, i.e. the number of nodes interfered, depending on the modulation and on the margin used:

margin

| bit rate | M1 | M2 | M3 | M4 |
|---|---|---|---|---|
| 24 | 6 | 7 | — | — |
| 18 | 5 | 5 | 6 | 6 |
| 12 | 4 | 4 | 5 | 5 |
| 9 | 3 | 3 | 4 | 4 |
| 6 | 2 | 3 | 3 | 4 |

At this point all the values calculated are included in a pricing function price_{mod,n} considering all the benefits as well as all the disadvantages of the different modulations and transmission powers calculated. The values of modulation and of transmission power minimizing the pricing function price_{mod,n} are assumed to be the best values from the point of view of optimisation of the local network performances.

The pricing function is price_{mod,n}=T_{mod}·N_{mod,n}+T_{mod,n}^{re-tx}·N_{mod,n} represents the time T_{mod} a transmission occupies the wireless medium, multiplied by the number of nodes N_{mod,n} interfered. In this formula for the pricing function price_{mod,n}, it is also taken into account that increasing the margin increases the probabilities of correct reception, while a corrupted messages implies a wasted time for retransmission; thus, the term T_{mod,n}^{re-tx} indicates the time wasted to retransmit the message 22 in case this is not correctly received; this value has a probabilistic nature and decreases as the margin increases.

The step [ii.d.1] of minimizing the interference time with neighbours 12, 14, 16 is described in more detail as follows:

Considering the equation price_{mod,n}=T_{mod}·N_{mod,n}+T_{mod,n}^{re-tx}·N_{mod,n} for the pricing function price_{mod,n},
the first term T_{mod}·N_{mod,n} represents the time during which N nodes are interfered, and
the second term T_{mod,n}^{re-tx}·N_{mod,n} represents the time wasted to retransmit the message 22 because the message 22 is not correctly decoded by the receiver unit 30; this is connected to the probability probₙ of not reception.

The communication device 100, in particular the decision unit 482, 482′, calculates this expression for all the previously considered values of the data rate and of the power margin, using the so calculated values of T_{mod}, N_{mod,n}, T_{mod,n}^{re-tx}.

Once all the various pricing functions price_{mod,n} are calculated, the communication device 100, in particular the decision unit 482, 482′ extracts the smallest value of price_{mod,n} to which the data rate “mod” and the transmission power margin “n” has been associated.

At this point the communication device 100, in particular the transmission unit 20, transmits the message 22 using the data rate “mod” and the power margin “m”.

The value T_{mod,n}^{re-tx} of the time wasted to retransmit the message 22 depends on the variance of the path loss: in fact higher variance implies that higher margin has to be used to assure a certain bit error rate. This value T_{mod,n}^{re-tx} can be calculated as T_{mod,n}^{re-tx}=T_{mod}·probₙ, where probₙ indicates the probability that a message 22 transmitted with the margin “n” is not correctly decoded by the receiver unit 30.

In the following, the step [ii.d.2] of selecting the resulting power/bit rate value is described in more detail:

The term or value T_{mod,n}^{re-tx}(, wherein T_{mod} is the same value as in the pricing formula while probe is the probability that the message 22 is not received) indicates the time wasted due to the fact that the message 22 is not correctly received. In this case, in fact the communication device 100, in particular the transmission unit 20, tries to re-transmit the message 22.

In this context, the term probₙ is probabilistic and depends on the margin “n” used to transmit; in order to calculate probₙ the probability of the received power being lower than the power needed to correctly decode the message 22 needs to be understood. This is equal to the probability that the instant path loss will overcome the average path loss of a value higher than the power margin chosen. So the calculation of the probability that the fast fading overcomes the chosen power margin is interesting.

The random fading is approximated with a Gaussian random variable, wherein the probability distribution function of the Gaussian random variable is the well-known expression:

$$f ( x ) = \frac{1}{σ \sqrt{2 π}} exp [ - \frac{1}{2} {( \frac{x - μ}{σ} )}^{2} ] .$$

The value of σ is known from the path loss variance; the value of μ is known from the average path loss.

By integrating the formula for f(x), the probability of random fading being lower than a given value of margin “n” can be obtained:

$$F ( n ) = {\int }_{0}^{n} f ( t ) d t .$$

Since the probability of the fading being higher than the margin is required the term 1−F(n) is considered. In this context, tabled values of F(n) are available in standard mathematics tables related to the function erf(x).

Finally; the value used in the pricing formula is probₙ=1−F(n).

After the step [ii.d.2] of selecting the resulting power/bit rate value, the message 22 can be sent in the final step [ii.e] by the transmitting unit 20.

The embodiment of the present invention as described above may advantageously further comprise one or more of the following details:

The path loss variance considered in the calculation (cf. steps [i.e] and the following above) is derived from the history of the path loss values stored in the neighbour table 410 and can be differentiated for every node 10, 12, 14, 16 or be averaged over a certain number of nodes or even over all nodes 10, 12, 14, 16.

The priority of the messages 22 also advantageously can be considered when calculating the transmission power; messages 22 with higher priority in fact can be transmitted with higher margin to increase the probability of being correctly decoded at the first transmission attempt. This condition can be included in the pricing mechanism (cf. step [ii.d.1] above) considering that a node 10, 12, 14, 16 is willed to “pay a higher price” to give higher reliability to a message 22 with higher priority.

Also the problem of packet collision or message collision can be taken into consideration in the pricing formula price_{mod,n}=T_{mod}·N_{mod,n}+T_{mod,n}^{re-tx}·N_{mod,n} (cf. step [ii.d.1] above). In fact, transmitting at higher power, beyond preventing other stations or nodes from using the channel can also increase the probability to create a packet collision at a receiver node, in particular at the receiving vehicle. So, a further term can be included in the pricing function price_{mod,n}=T_{mod}·N_{mod,n}+T_{mod,n}^{re-tx}·N_{mod,n} this further term penalizing a further increasing in the transmission power.

When an expected acknowledgement (ACK) is not received, the communication device 100 can attempt to retransmit the message 22, recalculating again the transmission power and the data rate from the previous formula (cf. steps [ii.b.2] and the following above) but considering that a higher price can be paid by the communication device 100, similar as explained for priority handling above.

In this way, a higher margin can be chosen that will increase the probability of correct reception. This is considered in the pricing function price_{mod,n}=T_{mod}·N_{mod,n}+T_{mod,n}^{re-tx}·N_{mod,n} by increasing the value of the term representing the probability probₙ of packet error.

If no acknowledgement (ACK) is received after a fixed number of trials, the communication device 100 stops attempting retransmission and sends a message back to the data manager 490, 490′ to inform that message 22 cannot be delivered.

The present method tends to solve two different aspects of the interference problem; in fact, the interference towards a vehicle can be seen in two different ways. On one side the vehicle requiring to send a message 22 is prevented from transmitting because it senses the medium busy; on the other side, a vehicle receiving a message 22 can be prevented to decode it correctly because another message 22 interferes with this message 22.

The first case is largely considered along the present invention; the second case is known as hidden node problem. In this context, it may be noticed that the pricing function takes into account both situations at the same time: the capability of diminishing the number of neighbour nodes, in particular neighbour vehicles 12, 14, 16, within the zone of interference in fact is advantageous for the two aspects of the interference problem.

The communication device 100 can also be included as a part of a more complex protocol stack for multi-purpose communication system 200.

FIG. 5 describes an example of evaluation of data rate and of transmission power in a high traffic scenario:

The communication of a reference vehicle 10 with a first neighbour vehicle 12 being within an inner circle c1 at a high data rate requires a transmission power interfering with too many third neighbour vehicles 16 at the border area, i.e. being arranged between a middle circle c2 and an outer circle c3. Thus, the pricing function (cf. step [ii.d.1] above) favours a transmission at a lower data rate and at a lower power with lower interference. The resulting interference corresponds to the middle circle c2.

FIG. 6 describes an example of evaluation of data rate and of transmission power in a low traffic scenario:

In this case, not many neighbours 12, 14, 16 are within the range of interference of the transmission at high data rate corresponding to the outer circle c3. Thus, the communication of the reference vehicle 10 with the first neighbour 12 within the inner circle c1 at a high data rate can be achieved without disturbing other neighbours 14, 16. Hence, the pricing function favours a transmission at high data rate and at high power in order to reduce the time occupancy of the channel because choosing lower data rate (<--> middle circle c2) will not reduce interference with other vehicles 14, 16.

FIG. 7 depicts a general architecture of a second embodiment of the central data processing unit 40′ in more detail, which harmoniously merges broadcast functionalities and unicast functionalities in a unique block:

The central processing unit 40′ is extended to include the functionalities of a communication device 100 being designed for calculating the transmission power in broadcast communication by processing information received from neighbouring nodes 12, 14, 16, in particular for calculating the path loss of every neighbouring node 12, 14, 16 by using the difference between the power transmitted value and the power at which the message 22 is received (cf. prior art article “Distributed Power Control for Reliable Broadcast in Inter-Vehicle Communication System” by Marco Ruffini and Hans-Jürgen Reumerman, VANET 2004 (workshop within MOBICOM 2004 conference), Philadelphia, Pa., USA, Sep. 26 to Oct. 1, 2004).

The central data processing unit 40′ comprises the same components as described in FIG. 2. Moreover, the central data processing unit 40′ comprises a retransmission controlling unit 440′ being provided with the receiving power 504 as calculated by the power estimating unit 50 (cf. FIG. 1) and being designed for evaluating if one or more of the arriving messages 22 have to be retransmitted.

The retransmission controlling unit 440′ is connected with the neighbour table 410, with the message analyzing unit 450 and with the decision unit 482′ being assigned to the power control subsystem 480′.

Said power control subsystem 480′ is designed for sorting the information regarding the neighbouring nodes 12, 14, 16 in the neighbour table 410 according to increasing path loss calculation values.

The following table specifies the details of the table 410 of the neighbours 12, 14, 16 and displays the grouping of the neighbour cars 12, 14, 16 in different path loss intervals or classes, as actuated by the power control subsystem 480′ (cf. FIG. 7):

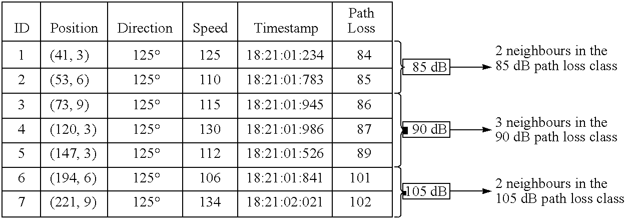

The power control subsystem 480′ is connected with the transmission interface 420, with the neighbouring table 410, and with the data managing unit 490′ comprising the data message generating unit 460′ including a warning message generating unit being designed for providing the power control subsystem 480′ with one or more warning messages.

Moreover, the data managing unit 490′ comprises
a hello message generating unit 470′ being designed for providing the decision unit 482′ with one or more hello messages, and
a data processing unit 492′.

Thus, according to the central processing unit 40′ messages can be generated
by the data message generator 460′ comprising a warning message generator,
by the hello message generator 470′, and
by the retransmission controlling unit 440′.

Finally, some typical scenarios are given where the communication system 200 can operate to deliver warning dissemination.

The communication system 200 is relevant for car-to-car communication where sensor-equipped cars 10, 12, 14, 16 interact cooperatively to avoid collisions. For example, car-to-car communication is considered crucial for intersection collision avoidance, in particular to avoid collisions when cars 12 are entering an intersection that should be kept free for instance for a fire truck 10 (cf. FIG. 8).

Likewise, the communication system 200 according to the present invention can be used for cooperative interaction of cars 10, 12, 14, 16 and for distributing messages 22, in particular warning messages, especially
in order to avoid collisions during lane change or merge maneuvers (cf. FIG. 9A),
for reporting an accident on the lanes used (cf. FIG. 9B), and
for reporting an invisible obstacle, for example an obscured or shadowed object (cf. FIG. 9C),
when vehicles are moving in different directions within the same area.

### LIST OF REFERENCE NUMERALS

100 communication device
10 reference node or respective node, in particular first vehicle
12 first neighbouring node, in particular first neighbouring vehicle, for example vehicle in central area or within inner circle c1
14 second neighbouring node, in particular node arranged between inner circle c1 and middle circle c2
16 third or further neighbouring node, in particular node in border area between middle circle c2 and outer circle c3
20 transmission unit, in particular sender block
204 signal from controller unit 40, 40′, in particular from transmission interface 420, to transmission unit 20
22 message, in particular hello message or warning message
23 receiving/transmitting antenna, assigned to transmission unit 20 as well as to receiver unit 30
30 receiver unit, in particular receptor block
304 signal from receiver unit 30 to controller unit 40, 40′, in particular to receiver interface 430
40 controller unit, in particular central data processing unit, for example relay control box (first embodiment; cf. FIG. 2)
40′ controller unit, in particular central data processing unit, for example relay control box (second embodiment; cf. FIG. 7)
410 neighbour list or neighbour table of controller unit 40, 40′
420 transmission interface of controller unit 40, 40′
430 receiver interface of controller unit 40, 40′
440′ retransmission controlling unit of controller unit 40′ (second embodiment; cf. FIG. 7)
450 message analyzing unit of controller unit 40, 40′
460 data message generating unit of controller unit 40 (first embodiment; cf. FIG. 2)
460′ data message generating unit of controller unit 40′ including warning message generator (second embodiment; cf. FIG. 7)
470 hello message generating unit of controller unit 40 (first embodiment; cf. FIG. 2)
470′ hello message generating unit of controller unit 40′ (second embodiment; cf. FIG. 7)
480′ power control subsystem of controller unit 40′ (second embodiment; cf. FIG. 7)
482 decision unit of controller unit 40 (first embodiment; cf. FIG. 2)
482′ decision unit of controller unit 40′ (second embodiment; cf. FIG. 7)
490 data managing unit of controller unit 40 (first embodiment; cf. FIG. 2)
490′ data managing unit of controller unit 40′ (second embodiment; cf. FIG. 7)
492 data processing unit of controller unit 40 (first embodiment; cf. FIG. 2)
492′ data processing unit of controller unit 40′ (second embodiment; cf. FIG. 7)
50 power estimating unit or power estimator block
504 receiving power at which arriving message is received and which is calculated by power estimating unit or power estimator block 50
60 localisation unit, in particular G[lobal]P[ositioning]S[ystem] unit, for example G[lobal]P[ositioning]S[ystem] block
604 signal from localisation unit 60 to controller unit 40, in particular to data managing unit 490, for example to data message generating unit 460 (first embodiment; cf. FIG. 2)
604′ signal from localisation unit 60 to controller unit 40′, in particular to data managing unit 490′, for example to data message generating unit 460′ (second embodiment; cf. FIG. 7)
62 localisation antenna, in particular G[lobal]P[ositioning]S[ystem] antenna, assigned to localisation unit 60
70 car bus interface
702 signal from communication device 100, in particular from car bus interface 70, to car bus intra-vehicle system 72
72 car bus intra-vehicle system
80 display unit
804 signal from controller unit 40, in particular from message analyzing unit 450 and/or from data processing unit 492, to display unit 80 (first embodiment; cf. FIG. 2)
804′ signal from controller unit 40′, in particular from message analyzing unit 450 and/or from data processing unit 492′, to display unit 80 (second embodiment; cf. FIG. 7)
90 danger sensing unit
904 signal from danger sensing unit 90 to controller unit 40, in particular to data managing unit 490, for example to data message generating unit 460 (first embodiment; cf. FIG. 2)
904′ signal, in particular sensor trigger signal, from danger sensing unit 90 to controller unit 40′, in particular to data managing unit 490′, for example to data message generating unit 460′ (second embodiment; cf. FIG. 7)
200 communication system or communication arrangement for inter-node, in particular inter-vehicle, communicating, in particular wireless local area network
c1 inner circle
c2 middle circle
c3 outer circle
i estimating path loss from hello messages transmitted, in particular broadcasted, by at least one neighbouring node (12, 14, 16)
i.a receiving hello messages broadcasted by neighbouring nodes 12, 14, 16
i.b determining receiving power 504 and determining path loss by comparing determined receiving power 504 or received signal strength of respective hello messages with transmit power indicated in header of respective hello messages
i.c storing instant path loss value for each neighbouring node 12, 14, 16 in neighbour list or neighbour table 410
i.c.1 storing instant path loss value for first neighbouring node 12 in neighbour list or neighbour table 410
i.c.2 storing instant path loss value for second neighbouring node 14 in neighbour list or neighbour table 410
i.c.3 storing instant path loss value for third or further neighbouring node 16 in neighbour list or neighbour table 410
i.d calculating general path loss characteristic plc
i.e calculating average path loss and path loss variance per neighbouring node 12, 14, 16
i.f updating neighbour list or neighbour table 410
ii selecting transmission parameters, in particular data rate and transmission power, for transmitting, in particular for unicasting, message (22), in particular data message
ii.a calculating interference time per available bitrate
ii.b.1 determining path loss to receiver unit 30
ii.b.2 calculating required transmission power per available bitrate
ii.c.1 applying various power margins
ii.c.2 calculating interference range per available power level
ii.d.1 minimizing interference time with neigbouring nodes 12, 14, 16
ii.d.2 selecting resulting power/bitrate value
ii.e sending message 22
n1 neighbouring car(s) being assigned to network identification number 1
n2 neighbouring car(s) being assigned to network identification number 2
n3 neighbouring car(s) being assigned to network identification number 3
n4 neighbouring car(s) being assigned to network identification number 4
n5 neighbouring car(s) being assigned to network identification number 5
n6 neighbouring car(s) being assigned to network identification number 6
n7 neighbouring car(s) being assigned to network identification number 7
plc path loss charactristic
x (variable of) distance
y (variable of) path loss value

1. A controller unit (40; 40′), in particular a central data processing unit, for example a relay control box, for controlling communication between and among mobile nodes (10, 12, 14, 16), in particular between and among vehicles, each node (10, 12, 14, 16) being designed for receiving and transmitting messages (22), in particular
at least one hello message, and/or
at least one data message, for example at least one warning message,
characterized by at least one decision unit (482; 482′) for choosing, in particular for calculating, the transmission parameters, in particular both the data rate and the transmission power, for at least part of the messages (22) to be transmitted, in particular for each data message to be transmitted, by processing at least part of the received messages (22), in particular by processing at least part of the arrived hello message, for example by processing at least one information regarding at least one of the respective neighbouring nodes (12, 14, 16) to which the message (22) ought to be transmitted, wherein the choice of the transmission parameters is such that
the interference of the messages (22) is minimized and
the overall local network throughput is maximized.

2. The controller unit according to claim 1, characterized in that the controller unit (40; 40′) comprises at least one neighbour list or neighbour table (410) being designed for storing at least part of the received messages (22), in particular for storing at least part of the received hello message comprising information regarding the neighbouring nodes (12, 14, 16), in particular regarding
the respective current position of the neighbouring nodes (12, 14, 16), and/or
the respective moving direction of the neighbouring nodes (12, 14, 16), and/or
the respective speed of the neighbouring nodes (12, 14, 16), and/or
at least one respective network identification number of the neighbouring nodes (12, 14, 16), and/or
the respective power at which the arriving message had been transmitted, and/or
at least one respective time stamp.

3. The controller unit according to claim 1, characterized by
at least one receiver interface (430) for receiving the arriving messages (22) and for adapting the controller unit (40; 40) to different transmission protocols; and/or
at least one message analysing unit (450)
being connected to the neighbour list or neighbour table (410) as well as to the receiver interface (430) and
being designed for evaluating the subject and/or the type of the received messages (22), in particular for evaluating if the respective received message (22) is a hello message and/or a data message,
for updating the information regarding the neighbouring nodes (12, 14, 16), in particular for updating the neighbour list or neighbour table (410), with at least part of the received messages (22), in particular with the hello message; and/or
at least one data managing unit (490; 490′)
comprising
at least one data message generating unit (460; 460′), in particular with a warning message generating unit,
at least one hello message generating unit (470; 470′), and
at least one data managing unit (492; 492′)
for processing at least part of the received messages (22) and/or
for triggering the data message generating unit (460; 460′) and/or the hello message generating unit (470; 470′) and
being connected to the message analysing unit (450) as well as to the decision unit (482; 482′); and/or
the decision unit (482; 482′)
being designed for providing at least one transmission interface (420) with the messages (22) being generated by the data message generating unit (460; 460′) and/or by the hello message generating unit (470, 470′) and
being connected to the neighbour list or neighbour table (410) as well as to the transmission interface (420) as well as to the data managing unit (490; 490′).

4. The controller unit (40′) according to claim 3, characterized by
the neighbour list or neighbour table (410) being designed for storing at least one path loss calculation value being calculated by the controller unit (40) by subtracting the receiving power (504) from the power at which the arriving message had been transmitted, the latter power being known from at least part of the arriving message, in particular from the hello message; and/or
at least one retransmission controlling unit (440′)
being connected to the neighbour list or neighbour table (410) as well as to the message analysing unit (450) as well as to the decision unit (482′),
being designed
for evaluating if the arriving message has to be retransmitted and
for calculating said transmission power, in case the arriving message has to be retransmitted, and
being providable with at least one copy of at least part of the received message (22), in particular of the data message, from the message analysing unit (450); and/or
at least one power control subsystem (480′)
comprising the decision unit (482′),
being connected to the neighbour list or neighbour table (410) as well as to the retransmission controlling unit (440′) as well as to the data managing unit (490′), and
being designed
for sorting the information regarding the neighbouring nodes (12, 14, 16) in the neighbour list or neighbour table (410) according to increasing path loss calculation values and/or
for grouping the information regarding the neighbouring nodes (12, 14, 16) in the neighbour list or neighbour table (410) according to discrete path loss calculation intervals,
in particular when the retransmission controlling unit (440′) and/or the data message generating unit (460′) and/or the hello message generating unit (470′) request to transmit the message (22).

5. A communication device (100) for communication between and among mobile nodes (10, 12, 14, 16), in particular between and among vehicles,
characterized by
at least one controller unit (40; 40′) according to claim 1,
at least one transmission unit (20), in particular at least one sender block, for transmitting the messages (22), in particular
for broadcasting the data message and/or the hello message and/or
for unicasting the data message and/or the hello message, and
at least one receiver unit (30), in particular at least one receptor block, for sensing the arriving messages (22), being transmitted, in particular broadcasted and/or unicasted, by at least one of the neighbouring nodes (12, 14, 16).

6. The communication device according to claim 5, characterized by
at least one power estimating unit (50)
being connected to the receiver unit (30) as well as to the controller unit (40; 40′) and
being designed
for calculating at least one receiving power (504) at which the respective arriving message (22) is received and
for providing the receiver interface (430) with the calculated receiving power (504); and/or
at least one localisation unit (60), in particular at least one G[lobal]P[ositioning]S[ystem] unit
being connected to the controller unit (40; 40′) and
being designed for receiving signals via at least one localisation antenna (62), for instance via at least one G[lobal]P[ositioning]S[ystem] antenna, in particular regarding the current position of the respective node (10) and/or regarding the moving direction of the respective node (10); and/or
at least one car bus interface (70)
being connected to the controller unit (40; 40′) and
being designed for supplying the controller unit (40; 40′) with the speed of the respective node (10); and/or
at least one display unit (80)
being connected to the controller unit (40; 40′), in particular to the data processing unit (492; 492′) and
being designed for displaying at least one message, in particular the data message (22); and/or
at least one danger sensing unit (90)
being connected to the controller unit (40; 40′) and
being designed for sensing at least one subject being relevant, in particular being dangerous, for the respective node (10).

7. A communication system (200) for wireless L[ocal]A[rea]N[etwork]s for communication between and among mobile nodes (10, 12, 14, 16), in particular between and among vehicles,
characterized by at least two communication devices (100) according to claim 5 wherein
at least one of the communication devices (100) is assigned to the reference node or respective node (10), in particular to the considered car, and
at least one of the communication devices (100) is assigned to the neighbouring node (12, 14, 16), in particular to the neighbouring car.

8. The communication system (200) according to claim 7, characterized in
that different types of messages (22) can be generated and transmitted by choosing both the data rate and the transmission power of the message (22); and/or
that for adapting the data rate and the transmission power of the message (22) to be transmitted at least one information of path loss received by neighbouring nodes (12, 14, 16) is used; and/or
that at least one price value is calculated based on
the number of neighbouring nodes (12, 14, 16), and/or
the path loss information of the neighbouring nodes (12, 14, 16), and/or
the data rate of the message (22) to be transmitted, for example the transmission packet length, and/or
the information about the sensitivity of modulation, and/or
the probability of the loss of the message (22) to be transmitted or of loss of the packet to be transmitted, and/or
the margin of the transmission power, and/or
the maximum transmission power, and/or
at least one threshold of channel assessment avoidance, and/or
the priority of the messages (22) to be transmitted; and/or
that the minimum price value is assigned to the minimum interfering mode, wherein a mode is referred to as a pair of data rate and transmission power; and/or
that at least one transmitting mode being not compatible with a maximum transmission power is, in particular automatically, eliminated; and/or
that the transmitted message (22) is retransmitted when no acknowledgement is received, by recalculating the minimum price value and by favouring the use of a higher margin of transmission power.

9. A communication protocol for controlling communication between and among mobile nodes (10, 12, 14, 16), in particular between and among vehicles, each node (10, 12, 14, 16) being designed for receiving and transmitting messages (22), in particular
at least one hello message, and/or
at least one data message, for example at least one warning message,
characterized in that the transmission parameters, in particular both the data rate and the transmission power, for at least part of the messages (22) to be transmitted, in particular for each data message to be transmitted, are chosen, in particular calculated, by processing at least part of the received messages (22), in particular by processing at least part of the arrived hello message, for example by processing at least one information regarding at least one of the respective neighbouring nodes (12, 14, 16) to which the message (22) ought to be transmitted, wherein the choice of the transmission parameters is such that
the interference of the messages (22) is minimized and
the overall local network throughput is maximized.

10. A method for controlling communication between and among mobile nodes (10, 12, 14, 16), in particular between and among vehicles,
characterized by executing at least one communication protocol according to claim 9.

11. The method according to claim 10, characterized in that the transmission parameters, in particular the data rate and the transmission power, are adapted on a per packet basis, in particular
that a pricing function is calculated for a range of margin values of the data rate and of the transmission power margin, based
on the estimated transmission time,
on the averaged neighbour path loss,
on the number of nodes (10, 12, 14, 16) interfered and/or
on the probable time wasted for retransmission of the message (22), and
that the values of the data rate and of the transmission power resulting in the lowest price are used to transmit the message (22), in particular the packet.

12. The method according to claim 10, characterized in
[i] that the path loss from hello messages transmitted, in particular broadcasted, by at least one neighbouring node (12, 14, 16) is estimated, in particular
[i.a] that the hello message broadcasted by at least one of the neighbouring nodes (12, 14, 16) is received,
[i.b] that at least one receiving power (504) is calculated at which the arriving hello message is received,
[i.c] that the instant path loss for each neighbouring node (12, 14, 16) is determined by subtracting the receiving power (504) from the power at which the hello message had been transmitted, the latter power being known from the received hello message, and that the determined instant path loss for each neighbouring node (12, 14, 16) is stored and/or updated in at least one neighbour list or neighbour table (410), in particular
[i.c.1] that the instant path loss values for the at least one first neighbouring vehicle (12), for example for the at least one neighbouring vehicle being in a central area, in particular within an inner circle (c1),
[i.c.2] that the instant path loss values for the at least one second neighbouring vehicle (14), for example for the at least one neighbouring vehicle being in a middle area, in particular between the inner circle (c1) and a middle circle (c2), and
[i.c 3] that the instant path loss values for the at least one further neighbouring vehicle (16) being in a border area, in particular between the middle circle (c2) and an outer circle (c3), are stored and/or updated in at least one neighbour list or neighbour table (410),
[i.d] that at least one general path loss characteristic (plc) is calculated, for example that the frequency of path loss measurements is determined depending on the frequency of hello messages being sent and/or received, and/or that it is decided over which path loss values their average should be calculated, and
[i.e] that the average path loss and the path loss variance per neighbouring node (12, 14, 16) are calculated, and
[ii] that the transmission parameters, in particular the data rate and the transmission power, are selected for transmitting, in particular for unicasting, the message (22), in particular the data message, in particular
[ii.a] that the interference time per available bit rate, for example the effective transmission time of the message (22) to be transmitted, is estimated and/or calculated,
[ii.b.1] that the power required for correctly decoding the transmitted message (22) upon reception is calculated, in particular that the path loss to at least one receiver unit (30) is determined,
[ii.b.2] that at least one required transmission power per available bit rate is calculated, for example that at least one modulated transmission power considering the receiving sensitivity is calculated, said sensitivity being known from the received hello message, wherein for example at least one transmitting mode being not compatible with a maximum transmission power is eliminated to be not considered in the following calculations,
[ii.c.1] that at least one buffered transmission power is calculated by applying at least one, preferably various, margin(s) of the transmission power to the calculation of the required transmission power, in particular of the modulated transmission power, per available bit,
[ii.c.2] that at least one interference range per available power level, in particular per buffered transmission power, is calculated, for example that the number of neighbouring nodes (12, 14, 16) being interfered when using the respective buffered transmission power is determined,
[ii.d.1] that at least one price value representing the transmission time, the interference range and the probability of not receiving the message (22) because of too low sensitivity of the receiver unit (30) is calculated for each buffered transmission power, in particular that the interference time with the neighbouring nodes (12, 14, 16) is minimized, and
[ii.d.2] that the resulting transmission power per bit rate value minimizing the interference time as well as the probability of not receiving is selected for transmitting the message (22).

13. Use of at least one controller unit (40; 40′) according to claim 1 for at least one wireless ad hoc network, in particular for at least one sensor network or for wireless local danger warning with the ability of self-adaptation to different circumstances and scenarios, for example for car-to-car communication, wherein cars interact cooperatively and distribute for example warning messages, especially for accident-free driving, for instance
in order to avoid collisions during lane change or merge maneuvers and
for reporting invisible obstacles, for example obscured or shadowed objects, when vehicles are moving in different directions within the same area.
